(19) United States
(12) Patent Application Publication
(10) Pub. No.: US 2025/0077572 A1
(43) Pub. Date: Mar. 6, 2025

(54) INFORMATION PROCESSING APPARATUS AND INFORMATION PROCESSING METHOD

(71) Applicant: Kioxia Corporation, Tokyo (JP)

(72) Inventors: Yuchieh Lin, Yokohama Kanagawa (JP); Yuji Nozawa, Yokohama Kanagawa (JP); youyang NG, Kamakura Kanagawa (JP); Takeshi Fujiwara, Yokohama Kanagawa (JP); Osamu Torii, Minato Tokyo (JP)

(73) Assignee: Kioxia Corporation, Tokyo (JP)

(21) Appl. No.: 18/820,977

(22) Filed: Aug. 30, 2024

(30) Foreign Application Priority Data
Sep. 5, 2023 (JP) 2023-144001

(51) Int. Cl. G06F 16/583; G06F 16/538; G06V 10/44; G06V 10/74; G06V 10/82

(52) U.S. Cl. CPC G06F 16/583; G06F 16/538; G06V 10/44; G06V 10/761; G06V 10/82

(57) ABSTRACT

An information processing apparatus includes a first neural network that extracts a feature of a query image and features of search object images; a processing circuitry detects a degree of similarity between the search object images and a query image based on the feature of the query image and the features of the search object images, and calculates a score of each of the search object images based on the degree of similarity between each of the search object images and the query image and feature transformation information relating to the degree of similarity between each of the search object images and the query image; a second neural network that outputs the feature transformation information; and a user interface that determines by a user the feature transformation information of each of the search object images based on the degree of similarity or the scores of the search object images.

### CROSS REFERENCE TO RELATED APPLICATIONS

This application is based upon and claims the benefit of priority from the prior Japanese Patent Application No. 2023-144001, filed on Sep. 5, 2023, the entire contents of which are incorporated herein by reference.

### FIELD

Embodiments described herein relate generally to an information processing apparatus and an information processing method.

### BACKGROUND

As the semiconductor processing technology has been advancing, the miniaturization of semiconductor integrated circuits has also been advancing. As a result, techniques for detecting minute defects on wafers at a high speed and with a high accuracy have been required.

There are various types of wafer defects. The size and the shape of defects vary depending on processing conditions, for example. In a case where defects are intended to be detected using wafer images, correctly finding the defects based on changes in shadings in the images may be difficult since the brightness and the contrast of the images may vary due to such a condition as an exposure condition.

### BRIEF DESCRIPTION OF THE DRAWINGS

FIG. 1 is a block diagram showing a schematic configuration of an information processing apparatus according to a first embodiment.

FIG. 2 is a block diagram of a first specific example of the information processing apparatus according to the first embodiment.

FIG. 3 is a block diagram of a second specific example of the information processing apparatus according to the first embodiment.

FIG. 4 shows a specific example of a user interface.

FIG. 5A shows an example of a query image, FIG. 5B shows examples of a plurality of search object images retrieved based on the degree of similarity, and FIG. 5C shows examples of a plurality of search object images retrieved based on Aligned features.

FIG. 6 is a block diagram showing a schematic configuration of an information processing apparatus according to a first modification of the first embodiment.

FIG. 7 is a flowchart showing a processing operation of the information processing apparatus according to the first modification of the first embodiment.

FIG. 8A shows an example in which there are features of three search object images in a feature space, of which two are determined as “Good” and the remaining one is determined as “Bad,” and FIG. 8B schematically shows a processing operation of an information processing apparatus 1 according to a second modification.

FIG. 9 is a block diagram of a main portion of the information processing apparatus according to the second modification of the first embodiment.

FIG. 10 is a flowchart showing a processing operation of the information processing apparatus according to the second modification of the first embodiment.

FIG. 11 is a flowchart showing the details of step S13 in FIG. 10.

FIG. 12 is a diagram for explaining a processing operation of an information processing apparatus according to a third modification of the first embodiment.

FIG. 13 is a flowchart showing the processing operation of the information processing apparatus according to the third modification of the first embodiment.

FIG. 14 is a flowchart showing the details of step S34 in FIG. 13.

FIG. 15 is a block diagram showing a schematic configuration of an information processing apparatus according to a second embodiment.

FIG. 16 shows a detailed configuration of the search feature extraction NN.

FIG. 17 is a diagram for explaining methods A, B, and C.

FIG. 18 shows all steps of the method A.

FIG. 19 is a diagram for explaining step S41.

FIG. 20 is a diagram for explaining step S42.

FIG. 21 is a diagram for explaining step S43.

FIG. 22 is a diagram for explaining step S44.

FIG. 23 is a diagram for explaining step S45.

FIG. 24 shows all steps of the method B.

FIG. 25 is a diagram for explaining step S50.

FIG. 26 is a diagram for explaining step S54.

FIG. 27 shows all steps of the method C.

FIG. 28 is a diagram for explaining step S60.

FIG. 29 is a diagram for explaining step S64.

### DETAILED DESCRIPTION

In order to solve the aforementioned problem, an embodiment of an information processing apparatus according to the present disclosure includes:
a first neural network configured to extract a feature of a query image and features of search object images;
a processing circuitry configured to:
detect a degree of similarity between each of the search object images and a query image based on the feature of the query image and the features of the search object images; and
calculate a score of each of the search object images based on the degree of similarity between each of the search object images and the query image and feature transformation information relating to the degree of similarity between each of the search object images and the query image;
a second neural network configured to output the feature transformation information based on the feature of the query image and the features of the search object images; and
a user interface configured to determine by a user the feature transformation information of each of the search object images based on at least one of the degree of similarity between each of the search object images and the query image or the score of each of the search object images,
wherein the processing circuitry is configured to provide, as feedback, the feature transformation information of the search object images determined by the user to the second neural network.

Embodiments of an information processing apparatus and an information processing method will now be described with reference to the accompanying drawings. Although main parts of the information processing apparatus will be mainly described below, the information processing apparatus may include an element or a function that is not illustrated or described. The following descriptions do not exclude any element or function that is not illustrated or described.

### First Embodiment

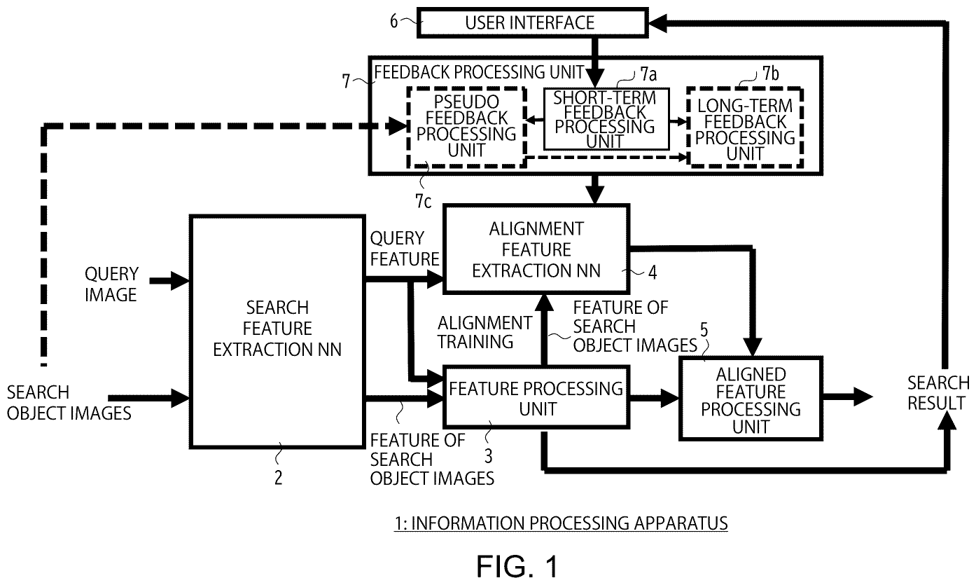

FIG. 1 is a block diagram showing a schematic configuration of an information processing apparatus 1 according to a first embodiment. The information processing apparatus 1 according to the first embodiment has a function to automatically determine whether each of a plurality of search object images is similar to a query image. The information processing apparatus 1 according to the first embodiment performs an operations including a training phase and an inference phase. In the training phase, whether an inputted search object images is similar to the query image is determined by a user, and machine learning is performed by using the determination result. In the inference phase, whether each of search object images that are inputted from outside is similar to the query image is determined based on the machine learning result.

As shown in FIG. 1, the information processing apparatus 1 according to the first embodiment includes a search feature extraction neural network (search feature extraction NN, first neural network) 2, a feature processing unit 3, an Alignment feature extraction neural network (Alignment feature extraction NN, second neural network) 4, an Aligned feature processing unit 5, a user interface 6, and a feedback processing unit 7. A computer or processing circuitry can perform at least part of the processes of the feature processing unit 3, the Aligned feature processing unit 5 and the feedback processing unit 7.

The search feature extraction NN 2 extracts features of the query image and features of the search object images. The search feature extraction NN 2 has a configuration such as a CNN (Convolutional Neural Network) or a ViT (Vision Transformer). The search feature extraction NN 2 is trained by updating a weight. Herein a trained search feature extraction NN 2 is intended to be used, and therefore the training phase of the search feature extraction NN 2 will not be described.

The feature processing unit 3 detects the degree of similarity between the query image and each of the search object images based on the features of the query image and the features of the search object images. The feature processing unit 3 sends the features of the search object images to the Alignment feature extraction NN 4.

The Alignment feature extraction NN 4 outputs an Aligned feature (feature transformation information) relating to the degree of similarity between the query image and each of the search object images based on the features of the query image and the features of the search object images. The Aligned feature may be binary information including, for example, “Good” indicating that the search object images are similar to the query image and “Bad” indicating that the search object images are not similar to the query image. Alternatively, the Aligned feature may be a value of a Sigmoid function which may have an arbitrary real number between 0 and 1. The Alignment feature extraction NN 4 may by trained by updating a weight. The training of the Alignment feature extraction NN 4 is called “Alignment training” herein. The transformation of the features performed by the Alignment feature extraction NN 4 is called “Alignment transformation” herein.

The training of the Alignment feature extraction NN 4 may have a cross-entropy loss, a focal loss, or an ID loss. The details of such losses are not described herein.

In the first embodiment, the inference phase starts after the training of the Alignment feature extraction NN 4 is finished. In the training phase of the Alignment feature extraction NN 4, the weight is updated by repeated operations of the feature processing unit 3, the Aligned feature processing unit 5, the user interface 6, and the feedback processing unit 7.

The Alignment feature extraction NN 4 may update the weight for each of a plurality of tags representing different search intents.

The Aligned feature processing unit 5 calculates a score of each search object images based on the degree of similarity between the query image and each of the search object images and the Aligned feature outputted from the Alignment feature extraction NN 4. The score calculated by the Aligned feature processing unit 5 is called “Aligned score” herein.

The user interface 6 has a user determine the Aligned features of the search object images based on at least one of the degree of similarity between the query image and each of the search object images and the Aligned scores of the search object images. For example, the user interface 6 determines by the user whether each of the search object images is “Good” or “Bad,” “Good” indicating that the search object images are similar to the query image and “Bad” indicating that the search object images are not similar to the query image. Before the feedback processing unit 7 performs a feedback operation, the user interface 6 has the user determine the Aligned feature of each search object images based on the degree of similarity. After the feedback processing unit 7 performs the feedback operation, the user interface 6 has the user determine the Aligned feature of each search object image based on the Aligned score. The Aligned feature outputted from the Alignment feature extraction NN 4 does not always match the Aligned feature determined by the user. The Alignment feature extraction NN 4 may output information (for example, a value of a Sigmoid function) obtained by transforming the Aligned feature (for example, “Good” or “Bad”) determined by the user as a new Aligned feature.

Before the feedback processing unit 7 performs the feedback operation, the user interface 6 shows to the user a list of search object images arranged in the order of the degree of similarity detected by the first feature processing unit 3. After the feedback processing unit 7 performs the feedback operation, the user interface 6 shows to the user a list of search object images arranged in the order of the magnitude of score.

The feedback processing unit 7 sends as a feedback the Aligned features of the search object images determined by the user to the Alignment feature extraction NN 4. In the training phase, the Alignment feature extraction NN 4 updates the weight based on the Aligned features sent as the feedback from the feedback processing unit 7, the feature of the query image, and the features of the search object images.

The feedback processing unit 7 may include at least one of a short-term feedback processing unit 7a, a long-term feedback processing unit 7b, and a pseudo feedback processing unit 7c. The details of these feedback processing units will be described later.

The user interface 6 and the feedback processing unit 7 are used in the training phase of the Alignment feature extraction NN 4. After the training phase of the Alignment feature extraction NN 4, when the Alignment feature extraction NN 4 is used for inference, the user interface 6 and the feedback processing unit 7 are not used.

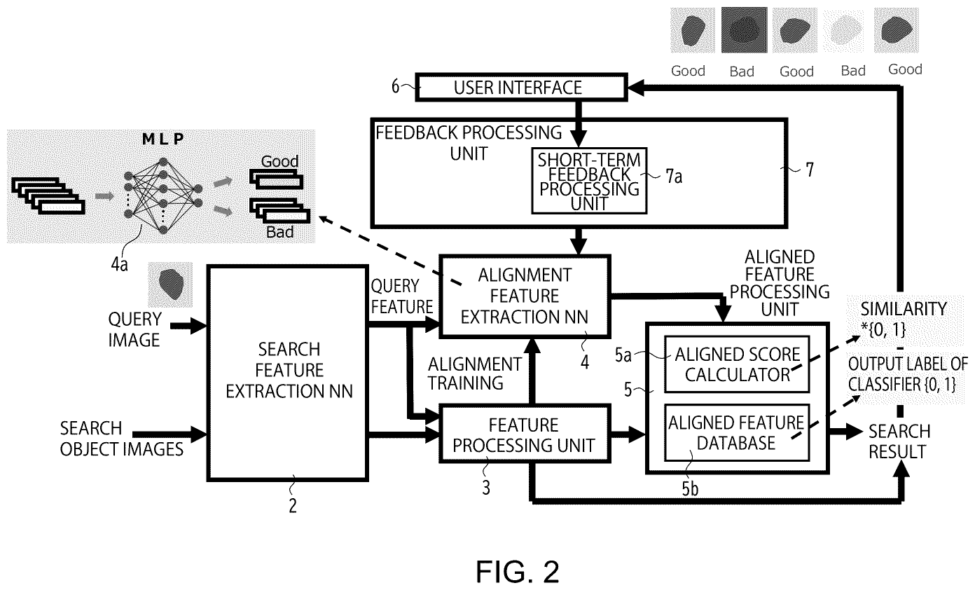

FIG. 2 is a block diagram showing a first specific example of the information processing apparatus 1 according to the first embodiment. The Aligned feature processing unit 5 includes an Aligned score calculator 5a and an Aligned feature database 5b.

The Aligned score calculator 5a calculates an Aligned score based on the Aligned feature outputted from the Alignment feature extraction NN 4 and the degree of similarity between each search object image outputted from the feature processing unit 3 and the query image. For example, the Aligned score calculator 5a calculates the Aligned score by multiplying the Aligned feature by the degree of similarity. The Aligned score calculator 5a may generate a label based on the Aligned score. The Aligned feature database 5b stores the Aligned feature outputted from the Alignment feature extraction NN 4.

In the first specific example shown in FIG. 2, the Aligned feature outputted from Alignment feature extraction NN 4 has a binary value, 0 or 1. For example, 1 represents “Good,” indicating that the degree of similarity between the search object images and the query image is high, and 0 represents “Bad,” indicating that the degree of similarity between the search object images and the query image is low. Alternatively, 0 may represent “Good” and 1 may represent “Bad.”

For example, the Alignment feature extraction NN 4 is a two-class classifier including a multi-layer perceptron (MLP) 4a. The Alignment feature extraction NN 4 updates the weight by backpropagation in order to minimize losses. As described above, the Alignment feature extraction NN 4 outputs the Aligned feature such as “Good” or “Bad” for each search object image.

The Aligned feature database 5b stores, for example, the degree of similarity and the Aligned feature of each search object image with respect to the query image.

The Aligned feature processing unit 5 provides to the user interface 6 the Aligned score for each of the search object images. The information provided to the user interface 6 is not only the Aligned score but may include the features of the query image and the features of each search object image.

The user interface 6 and the feedback processing unit 7 send feedback of the Aligned feature for each of the search object images to the Alignment feature extraction NN 4 based on the information sent from the Aligned feature processing unit 5.

The feedback processing unit 7 includes the short-term feedback processing unit (first feedback processing unit) 7a, which performs a feedback operation for each query image.

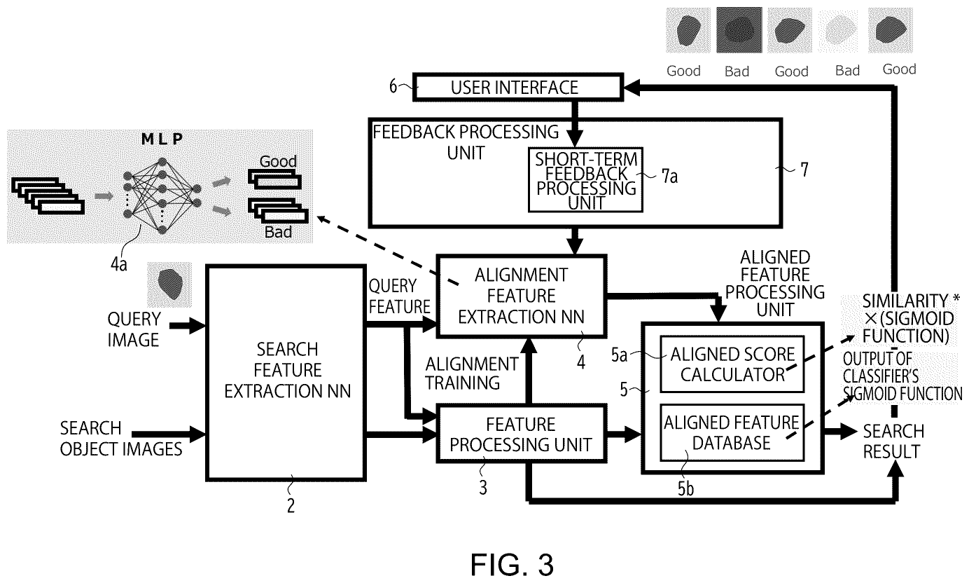

FIG. 3 is a block diagram showing a second specific example of the information processing apparatus 1 according to the first embodiment. The information processing apparatus 1 according to the second specific example differs from the information processing apparatus 1 according to the first specific example in that the Aligned feature outputted from the Alignment feature extraction NN 4 is a value of a Sigmoid function. The Aligned score calculator 5a included in the information processing apparatus 1 according to the second specific example calculates the Aligned score by multiplying the Aligned feature, which is a value of the Sigmoid function, by the degree of similarity outputted from the feature processing unit 3.

Although the value of the Aligned score differs between the first specific example and the second specific example, the Aligned score is provided to the user interface 6 in both the first specific example and the second specific example. The user interface 6 and the feedback processing unit 7 have the user determine the Aligned feature of each search object image based on the Aligned score, the features of the query image, and the features of each search object image, and send feedback of the determined Aligned feature to the Alignment feature extraction NN 4.

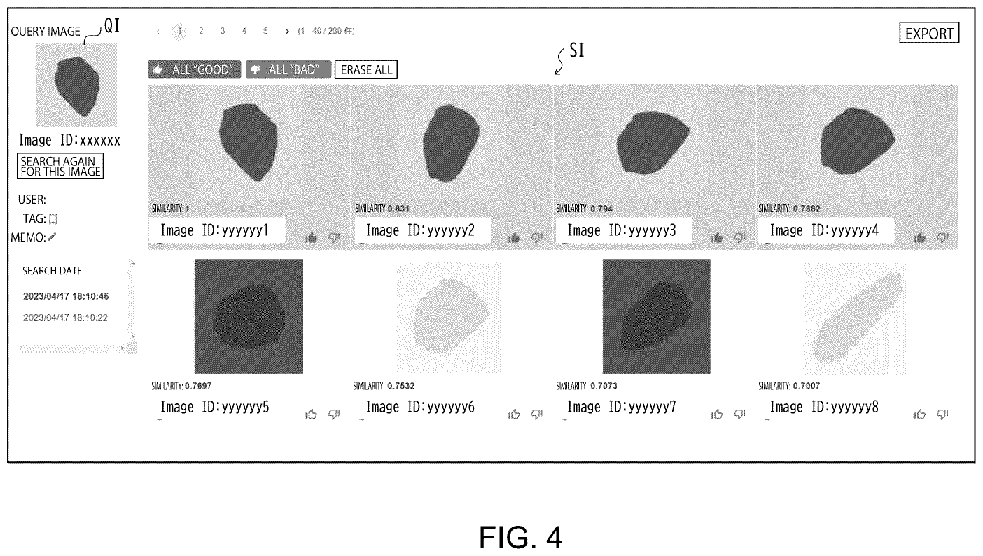

FIG. 4 shows a specific example of the user interface 6. As shown in FIG. 4, the user interface 6 includes a graphical user interface (GUI), for example. FIG. 4 shows an example of a window of a GUI on a display of a display device, having a query image QI, a plurality of search object images SI, and the degree of similarity between the query image QI and each of the search object images SI expressed as a numerical value. On the display shown in FIG. 4, the user may mark each of the search object images SI with “Good” or “Bad” based on the numerical value indicating the degree of similarity. For example, the user may mark the search object images SI for which the degree of similarity is equal to or greater than a predetermined reference value with “Good,” and mark the search object images SI for which the degree of similarity is less than the predetermined reference value with “Bad.”

After the user assigns “Good” or “Bad” to each search object image SI, the result is fed back as an Aligned feature to the Alignment feature extraction NN 4.

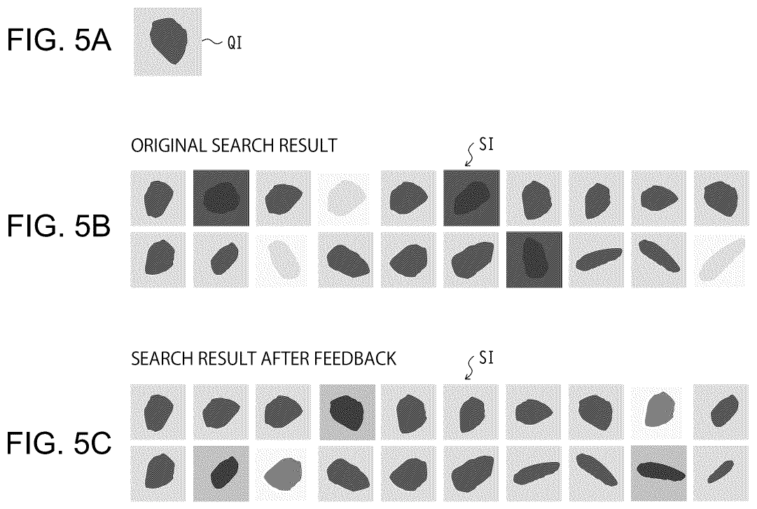

FIG. 5A shows an example of the query image QI, FIG. 5B shows examples of a plurality of search object images SI retrieved based on the degree of similarity outputted from the feature processing unit 3, and FIG. 5C shows examples of a plurality of search object images SI retrieved based on the Aligned features outputted from the Alignment feature extraction NN 4. In the following descriptions, the search approach shown in FIG. 5B is called “no-feedback approach,” and the search approach shown in FIG. 5C is called “feedback approach.”

If search object images SI that are similar to the query image QI are retrieved based on the degree of similarity outputted from the feature processing unit 3, it may be possible that all the retrieved search object images SI may not be similar to the query image QI as shown in FIG. 5B. In contrast, if a search is performed based on the Aligned features, the retrieved search object images SI may be more similar to the query image QI.

The configurations shown in FIGS. 2 and 3 are intended to search for a plurality of search object images based on a single search intent, but the information processing apparatus 1 may have a configuration for dealing with a plurality of search intents. The “search intent” means a search condition for searching for a search object image that is similar to a query image.

### First Modification of First Embodiment

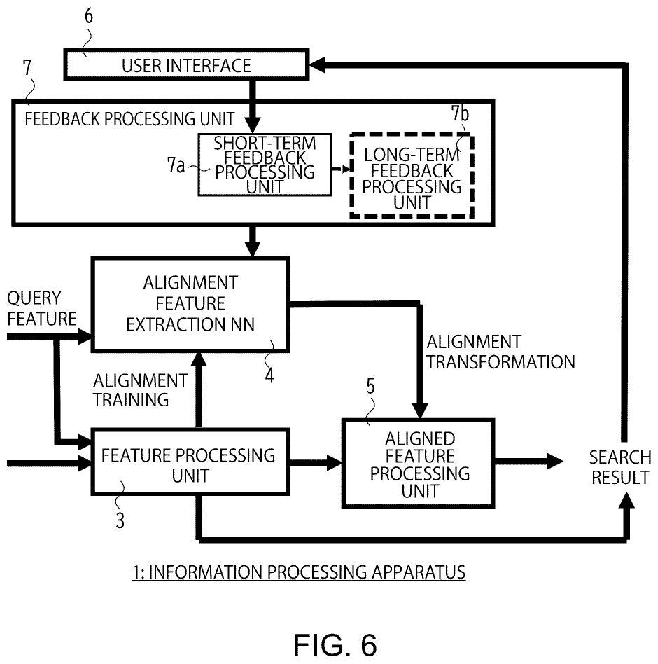

FIG. 6 is a block diagram showing a schematic configuration of an information processing apparatus 1 according to a first modification of the first embodiment. The information processing apparatus 1 according to the first modification differs from the information processing apparatus 1 shown in FIG. 2 or FIG. 3 in that the feedback processing unit 7 includes the long-term feedback processing unit (second feedback processing unit) 7b in addition to the short-term feedback processing unit 7a, and that the weights of the Alignment feature extraction NN 4 are updated for each tag.

The “tag” is information for identifying a search intent. The short-term feedback processing unit 7a updates the weights of the Alignment feature extraction NN 4 based on the Aligned features of the search object images determined by the user with respect to each of a plurality of tags. The long-term feedback processing unit 7b updates the weights of the Alignment feature extraction NN 4 based on repeated operations of the feature processing unit 3, the Aligned feature processing unit 5, the user interface 6, and the feedback processing unit 7 for each of a plurality of query images with respect to the same tag. The short-term feedback processing unit 7a outputs feedback processing information relating to each tag as a log. The Alignment feature extraction NN 4 functions as an extractor that outputs the Aligned feature for each tag.

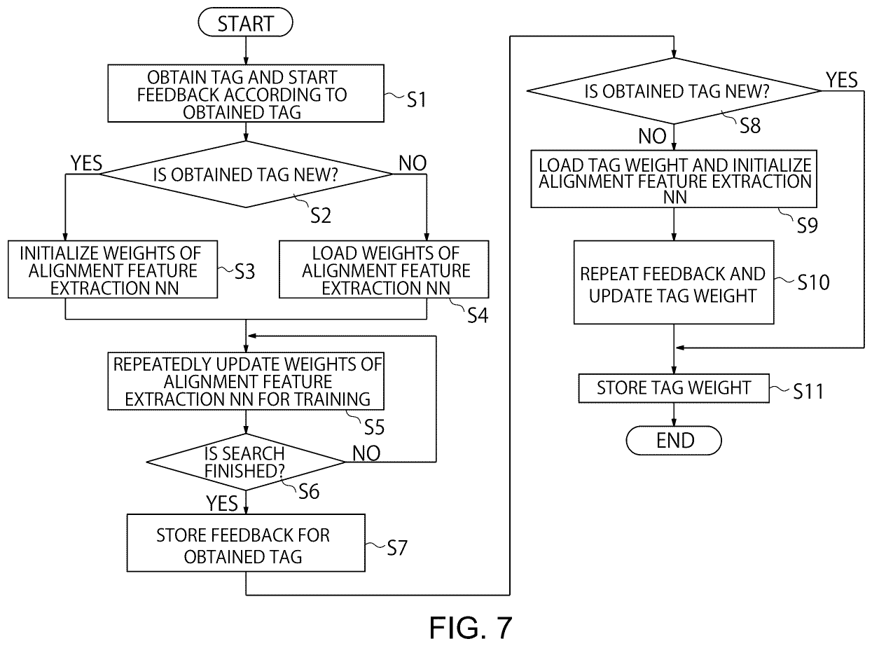

FIG. 7 is a flowchart showing a processing operation of the information processing apparatus 1 according to the first modification of the first embodiment. First, a tag is obtained, and a feedback operation of the short-term feedback processing unit 7a is started based on the obtained tag (step S1).

Next, whether the tag is new is determined (step S2). If the tag is new, the weights of the Alignment feature extraction NN 4 are initialized to have a random value (step S3). If not, a stored weight is loaded to initialize the weights of the Alignment feature extraction NN 4 (step S4). At or after the second time of the training phase, an image with a new Aligned score calculated by the Aligned feature processing unit 5 based on a new Aligned feature inferred by the Alignment feature extraction NN 4 based on the information provided by the user is presented to the user.

After step S3 or S4, the short-term feedback processing unit 7a repeats the feedback operation to perform training to update the weights of the Alignment feature extraction NN 4 (step S5).

Thereafter, whether the training is finished for searching for a plurality of search object images that are similar to the query image with respect to the obtained tag is determined (step S6). If the training is determined not to have finished yet, step S5 and step S6 are repeated.

If the result of step S6 becomes “YES,” the feedback operation of the short-term feedback processing unit 7a is finished, and the result of the feedback operation (for example, weight) with respect to the tag obtained in step S1 is stored (step S7).

Subsequently, whether the tag is new is determined (step S8). If not, a stored weight of the tag is loaded to initialize the weights of the Alignment feature extraction NN 4 (step S9).

Next, the feedback operation of the feedback processing unit 7 is repeated for a plurality of query images to update the weight of the tag (step S10). The feedback operation of step S10 is performed by the long-term feedback processing unit 7b of the feedback processing unit 7.

If step S10 is finished or the tag is determined to be new in step S8, the weight of the tag is stored (step S11) and the processing operation shown in FIG. 7 is finished.

According to the flowchart shown in FIG. 7, the training phase for updating the weights of the Alignment feature extraction NN 4 may be performed for each tag having a different search intent. This enables the Alignment feature extraction NN 4 to be trained to make inferences for a plurality of search intents.

### Second Modification of First Embodiment

The Aligned feature is binary information including “Good” and “Bad,” for example. In this case, if the number of search object images determined as “Good” and the number of search object images determined as “Bad” are small, the Alignment feature extraction NN 4 may not be correctly trained.

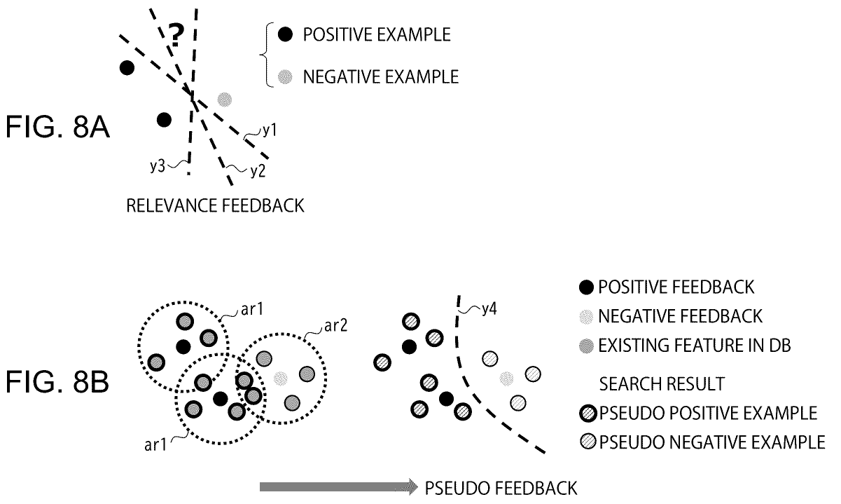

FIG. 8A shows an example in which there are features of three search object images in a feature space, of which two are determined as “Good” and the remaining one is determined as “Bad.” The features determined as “Good” are labeled as “positive example,” and the feature determined as “Bad” is labelled as “negative example” in FIG. 8A. Since whether a feature is a positive example or a negative example may be obtained by feedback, it may be called “positive feedback” or “negative feedback” herein.

In the case of FIG. 8A, the number of features determined as the positive example and the negative example is small. Therefore, the boundary between positive and negative examples cannot be uniquely determined. In FIG. 8A, broken lines y1, y2, and y3 are candidates for the boundary in the feature space. If there are a plurality of candidates for the boundary as shown in FIG. 8A, an error may be caused in the determination result for determining “Good” or “Bad” regardless of which candidate is selected.

FIG. 8B schematically shows a processing operation of the information processing apparatus 1 according to the second modification. The information processing apparatus 1 according to the second modification extracts positive pseudo features (pseudo positive examples) around a positive example determined as “Good” and negative pseudo features (pseudo negative examples) around a negative example determined as “Bad” among various existing features of search object images (“existing features”) that are already stored in a database (not shown), and sets a range of positive examples ar1 including the pseudo positive examples and a range of negative examples ar2 including the pseudo negative examples. The pseudo positive examples and the pseudo negative examples in an overlapping region between the range of positive examples ar1 and the range of negative examples ar2 are removed. As a result, the boundary between “Good” and “Bad” (the broken line y4 shown in FIG. 8B) may be defined easily. The series of operations described above is called “pseudo feedback.”

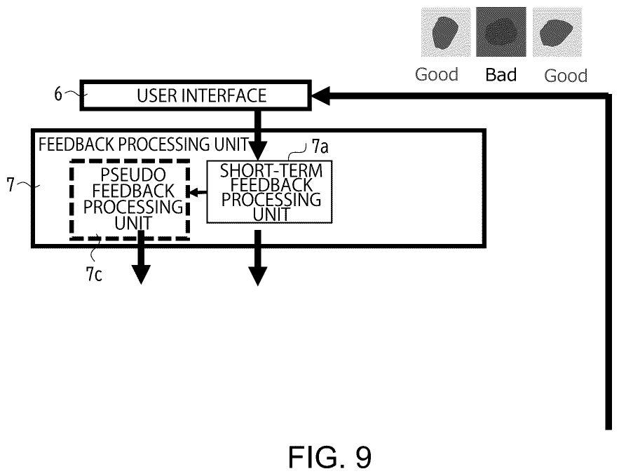

FIG. 9 is a block diagram of a main portion of the information processing apparatus 1 according to the second modification of the first embodiment. Although FIG. 9 only shows the feedback processing unit 7 and the user interface 6, the information processing apparatus 1 according to the second modification also includes the search feature extraction NN 2, the feature processing unit 3, the Alignment feature extraction NN 4, and the Aligned feature processing unit 5, like the information processing apparatus 1 shown in FIG. 2 or FIG. 6.

As shown in FIG. 9, the information processing apparatus 1 according to the second modification differs from the information processing apparatus 1 shown in FIG. 2 or FIG. 6 with respect to the internal configuration of the feedback processing unit 7. The feedback processing unit 7 according to the second modification includes the short-term feedback processing unit 7a and the pseudo feedback processing unit (third feedback processing unit) 7c.

The processing operation of the short-term feedback processing unit 7a is the same as that of the short-term feedback processing unit 7a shown in FIG. 2 or FIG. 6. The pseudo feedback processing unit 7c generates a pseudo feature that meets predetermined conditions for a plurality of features for each of which the Aligned feature is known. The predetermined conditions include, for example, at least one of a condition with respect to the distances to the features in a feature space and a condition with respect to an image processing method. The pseudo feedback processing unit 7c generates an Aligned feature for a pseudo search object image corresponding to the pseudo feature and sends the generated Aligned feature as feedback to the Alignment feature extraction NN 4.

The weights of the Alignment feature extraction NN 4 included in the information processing apparatus 1 according to the second modification are updated based on the Aligned features of a plurality of search object images and the Aligned feature of the pseudo search object image.

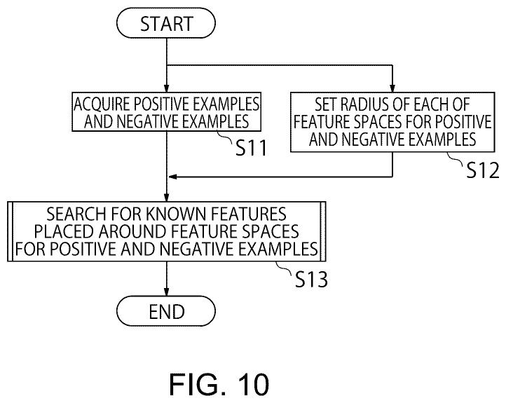

FIG. 10 is a flowchart showing the processing operation of the information processing apparatus 1 according to the second modification of the first embodiment. In the following descriptions, the feature of a search object image determined as “Good” is called “positive feature,” and the feature of a search object image determined as “Bad” is called “negative feature.”

First, all of positive examples and negative examples are acquired (step S11). As described above, the positive examples are features of search object images determined as “Good,” and negative examples are features of search object images determined as “Bad.”

In parallel to step S11, the radius of the feature space of the positive examples and the radius of the feature space of the negative examples are set (step S12). The positive feature space indicates the range where the positive examples are placed, and the negative feature space indicates the range where the negative example are placed.

Next, known features around the feature space of the positive examples are searched for, and known features around the feature space of the negative feature space are searched for (step S13).

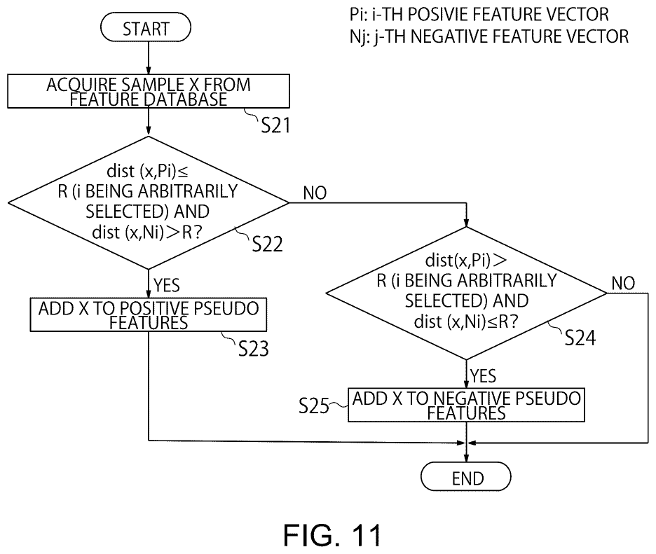

FIG. 11 is a flowchart showing the details of the operation of step S13 in FIG. 10. An arbitrary existing feature included in the feature database of the features of search object images is acquired as a sample X (step S21).

Next, whether a condition is met is determined, the condition being that a distance dist (X, Pi) between the sample X and a positive feature vector Pi is equal to or less than a radius R of the positive feature space and a distance dist (X, Nj) between the sample X and a negative feature vector Nj is greater than a radius R of the negative feature space (step S22). If the result of step S22 is YES, the sample X is added to the positive pseudo features (step S23).

If the result of step S22 is NO, whether a condition is met is determined, the condition being that the distance dist (X, Pi) between the sample X and the positive feature vector Pi is greater than the radius R of the positive feature space and the distance dist (X, Nj) between the sample X and the negative feature vector Nj is equal to le less than the radius R of the negative feature space (step S24). If the result of step S24 is YES, the sample X is added to the negative pseudo features (step S25). After step S23 or S25 is finished, or if the result of step S24 is NO, the operation shown in FIG. 11 is finished.

### Third Modification of First Embodiment

An information processing apparatus 1 according to a third modification of the first embodiment generates a pseudo feature by an approach that is different from the approach of the second modification.

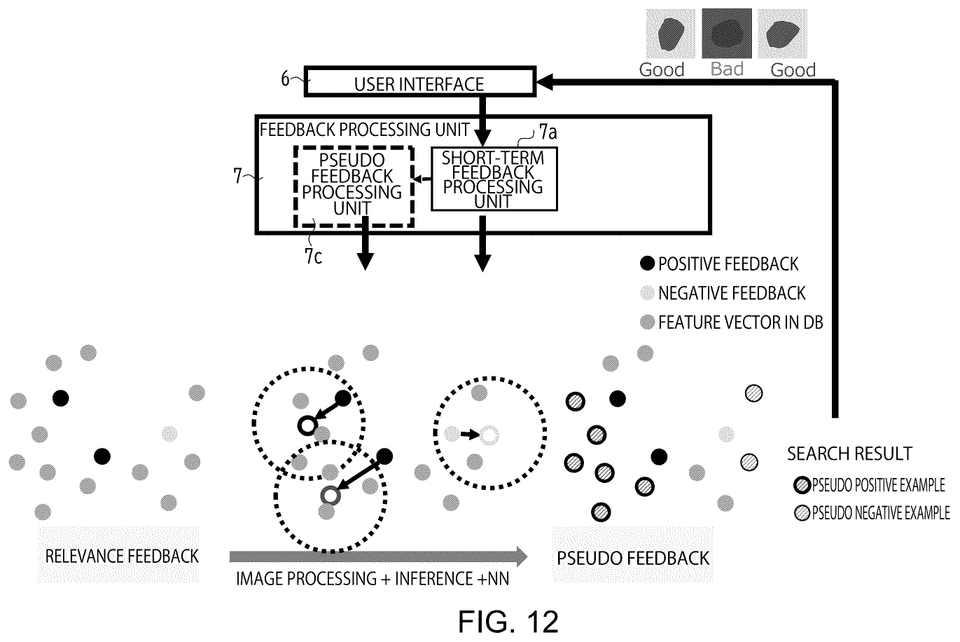

FIG. 12 is a diagram for explaining a processing operation of the information processing apparatus 1 according to the third modification of the first embodiment. The information processing apparatus 1 according to the third modification includes a feedback processing unit 7 that has the same configuration as the feedback processing unit 7 of the information processing apparatus 1 according to the second modification. The information processing apparatus 1 performs image processing based on the feature of a search object image determined as “Good” (positive example) to form an image, and generates an Aligned feature again using the generated image. The newly generated Aligned feature may be used as a pseudo feature to increase the number of Aligned features. The image processing includes, for example, cropping a part of the image, and improving the contrast of the image. The specific contents of the image processing may be arbitrarily defined.

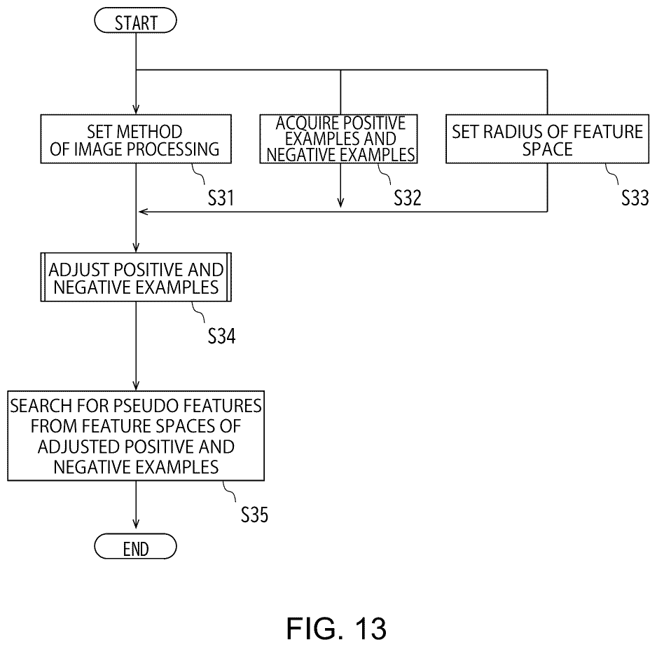

FIG. 13 is a flowchart showing the processing operation of the information processing apparatus 1 according to the third modification of the first embodiment. First, an approach of image processing is set (step S31), positive examples and negative examples are acquired by a feedback operation (step S32), and a radius of each feature space is set (step S33). The order of steps S31 to S33 may be arbitrarily determined.

Next, the positive examples and the negative examples are adjusted (step S34). The details of step S34 will be described later.

Thereafter, a pseudo feature is searched for from the feature spaces of the adjusted positive example and the adjusted negative example (step S35).

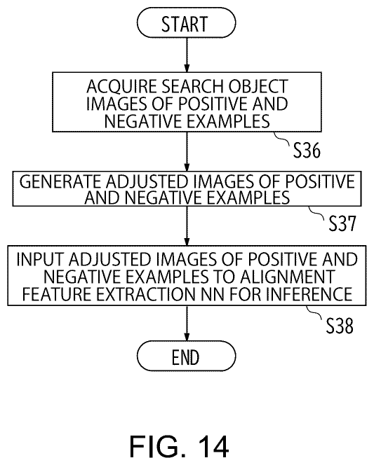

FIG. 14 is a flowchart showing the details of step S34 in FIG. 13. First, search object images corresponding to positive examples and search object images corresponding to negative examples are acquired based on feedback (step S36).

Next, the image processing set in step S31 is performed on the search object images acquired in step S36 to generate images of the adjusted positive examples and images of the adjusted negative examples (step S37).

Thereafter, the images of the adjusted positive example and negative examples are inputted to the Alignment feature extraction NN 4 for interference (step S38).

As described above, in the first embodiment, the Alignment feature extraction NN 4 that outputs the Aligned feature is trained. The Aligned feature is feature transformation information relating to the degree of similarity of each of the search object images retrieved with respect to the query image, and includes, for example, binary information such as “Good” and “Bad.” In the first embodiment, the Aligned features indicating the result of the determination by the user of whether each of the search object images is similar to the query image are fed back to the Alignment feature extraction NN 4 to train the Alignment feature extraction NN 4. By using the search feature extraction NN 2, which has already been trained, and the Alignment feature extraction NN 4, it is possible to easily calculate the Aligned score indicating the degree of similarity of each of the search object images with respect to the query image. The reliability of the Aligned score is higher than a score calculated based on the degree of similarity of each search object image with respect to the query image. Therefore, it is possible to make a list of a plurality of search object images that are similar to a query image in the order of the degree of similarity.

### Second Embodiment

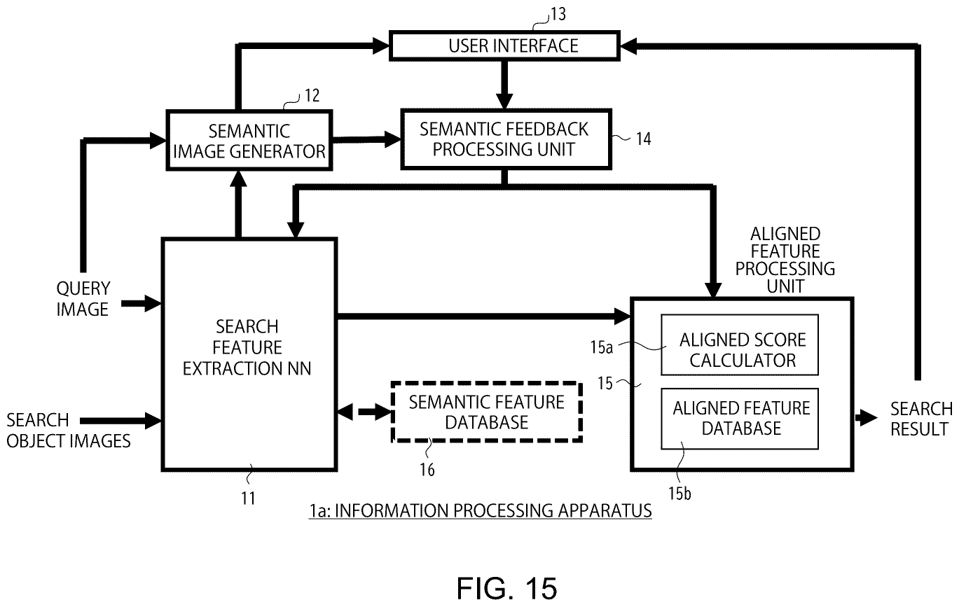

FIG. 15 is a block diagram showing a schematic configuration of an information processing apparatus 1a according to a second embodiment. As shown in FIG. 15, the information processing apparatus 1a according to the second embodiment includes a search feature extraction neural network (search feature extraction NN, first neural network) 11, a semantic image generator (intermediate image generator) 12, a user interface 13, a semantic feedback processing unit 14, and an Aligned feature processing unit (score calculator) 15. A computer or processing circuitry can perform at least part of the processes of the semantic image generator 12, the semantic feedback processing unit 14 and the Aligned feature processing unit 15.

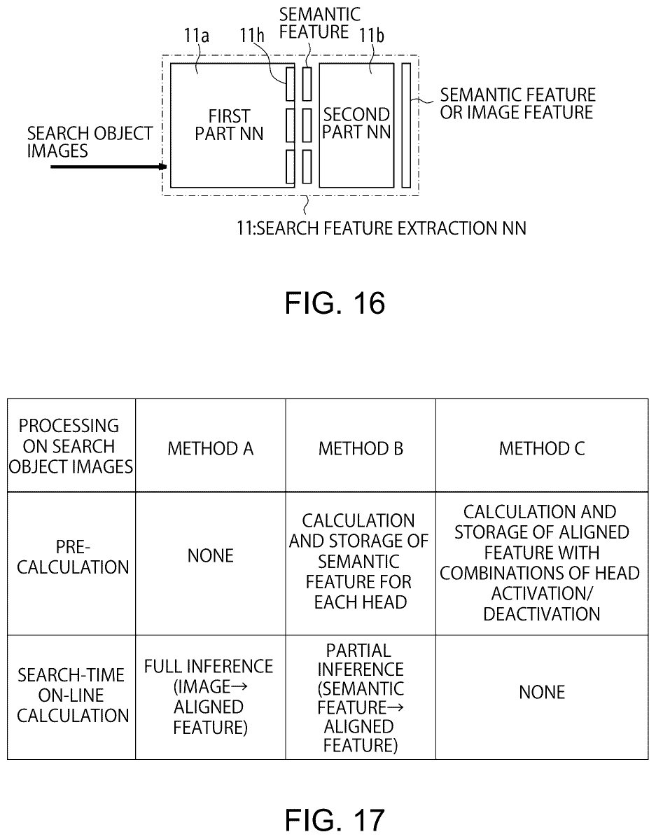

FIG. 16 shows a detailed configuration of the search feature extraction NN 11. As shown in FIG. 16, the search feature extraction NN 11 has a vision transformer (VT) configuration including a plurality of heads 11h having a multi-head attention mechanism. The search feature extraction NN 11 includes a first part neural network (first part NN) 11a that extends from an input layer to an intermediate layer and a second part neural network (second part NN) 11b that extends from the intermediate layer to an output layer, and outputs feature transformation information relating to the degree of similarity of each of search object images with respect to a query image. The feature transformation information is called Aligned feature herein.

The semantic image generator 12 generates a plurality of semantic images based on a plurality of semantic features outputted from the first part NN 11a and the query image. The semantic feature corresponds to an intermediate feature outputted from the first part NN 11a.

The user interface 13 have a user select one or more semantic images from a plurality of semantic images.

The semantic feedback processing unit 14 selects a semantic feature inputted to the second part NN 11b from a plurality of semantic features outputted from the first part NN 11a based on the one or more semantic images selected by the user. Specifically, each of the heads 11h at an output portion of the first part NN 11a is activated or deactivated according to the semantic image selected by the user. The activated head 11h outputs a corresponding semantic feature, and the deactivated head 11h outputs no corresponding semantic feature. The one or more semantic features outputted from the heads 11h are inputted to the second part NN 11b.

The Aligned feature processing unit 15 calculates scores of a plurality of search object images based on at least one of the Aligned feature of each of the search object images with respect to the query image outputted from the search feature extraction NN 11 and the semantic image selected by the user.

In more detail, after the user selects an intermediate image and activates or deactivates each of the heads 11h, the Aligned feature processing unit 15 calculates a score (Aligned score) indicating the degree of similarity between the Aligned feature of the query image (first feature transformation information), which is inferred by inputting the query image to the neural network 11, and the Aligned feature of the search object images (second feature transformation information) inferred by inputting the search object images to the neural network 11, and outputs a result as the search result.

The Aligned feature processing unit 15 includes an Aligned score calculator 15a and an Aligned feature database 15b. The Aligned score calculator 15a calculates the score described above. The Aligned feature database 15b stores the Aligned feature.

The user interface 13 presents the value of the score outputted from the Aligned feature processing unit 15 before the user selects the intermediate image, and has the user select one or more intermediate images from a plurality of intermediate images.

If all of the heads 11h are activated, the search feature extraction NN 11 outputs the feature of the query image or the search object images inputted to the feature extraction NN 11. If a part of the heads 11h are deactivated, the search feature extraction NN 11 outputs the Aligned feature corresponding to the query image or the search object images inputted to the extraction NN 11.

The information processing apparatus 1a according to the second embodiment may also include a semantic feature database 16 shown by a broken line in FIG. 15. The semantic feature database 16 inputs the search object images to the search feature extraction NN 11 before the inference starts, and stores the semantic feature outputted from the first part NN 11a.

As described above with reference to FIG. 16, the search feature extraction NN 11 includes the first part NN 11a extending from the input layer to the intermediate layer and the second part NN 11b extending from the intermediate layer and the output layer. The number of layers of each of the first part NN 11a and the second part NN 11b may be arbitrarily selected.

The first part NN 11a includes a plurality of heads 11h each outputting a different semantic feature. Each of the head 11h may be independently activated or deactivated. Whether each of the heads 11h is activated or deactivated is determined by the user via the semantic feedback processing unit 14. The user determines whether each head 11h is activated or deactivated by referring to the score of the semantic feature sent from the Aligned feature processing unit 15. The semantic feature outputted from the activated head 11h is inputted to the second part NN 11b. If the semantic features of a part of the heads 11h are inputted to the second part NN 11b, each of the Aligned features outputted from the second part NN 11b has a different value depending on the type of the head 11h outputting the semantic feature.

As described above, the value of the Aligned feature outputted from the search feature extraction NN 11 may be changed by switching the activation and deactivation of a plurality of heads 11h. For example, the combinations of activated and deactivated heads 11h may be changed for each search intent.

The information processing apparatus 1a according to the second embodiment performs processing of the search object images by any of three methods A, B, and C. FIG. 17 is a diagram for explaining the methods A, B, and C. In the method A, no calculation is performed before inference, and the query image and a plurality of search object images are inputted to the search feature extraction NN 11 at the time of inference to infer the Aligned feature of each search object image. The inference in the method A may be called “full inference” herein. The calculation processing at the time of the inference may be called “search-time on-line calculation” herein.

In the method B, the semantic feature of each head 11h included in the first part NN 11a of the search feature extraction NN 11 is calculated as pre-calculation before starting inference. In the method B, the pre-calculated semantic feature of each head 11h is stored in a memory. The memory may be included in the information processing apparatus 1a or disposed outside the information processing apparatus 1a. Since the semantic feature is pre-calculated, the search-time on-line calculation may be performed at a higher speed.

In the method C, as a pre-calculation before inference, the Aligned feature is calculated and stored based on an arbitrary combinations of activated and deactivated heads 11h in the first part NN 11a of the search feature extraction NN 11. Since the Aligned feature is pre-calculated, the search-time on-line calculation may be performed at a further higher speed than the method B. The methods A, B, and C will be described in more detail below.

### (Method A)

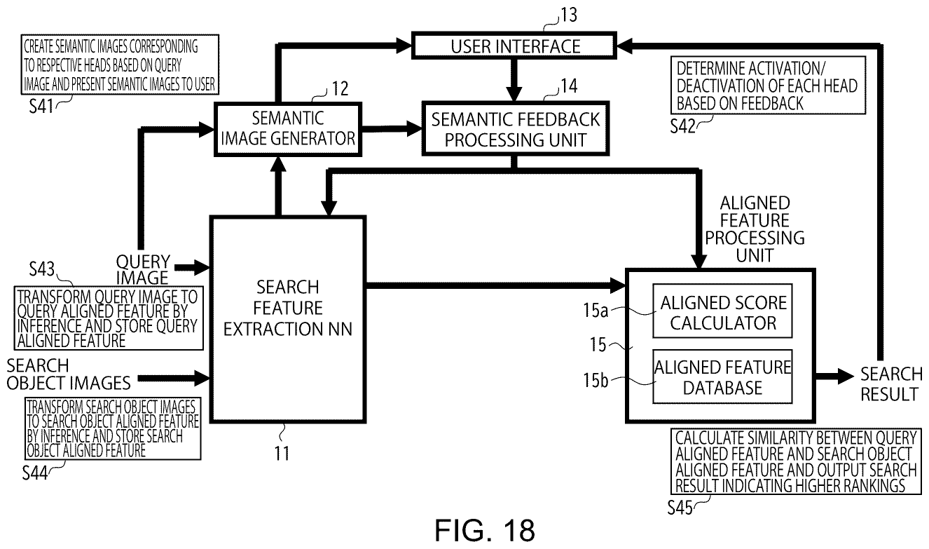

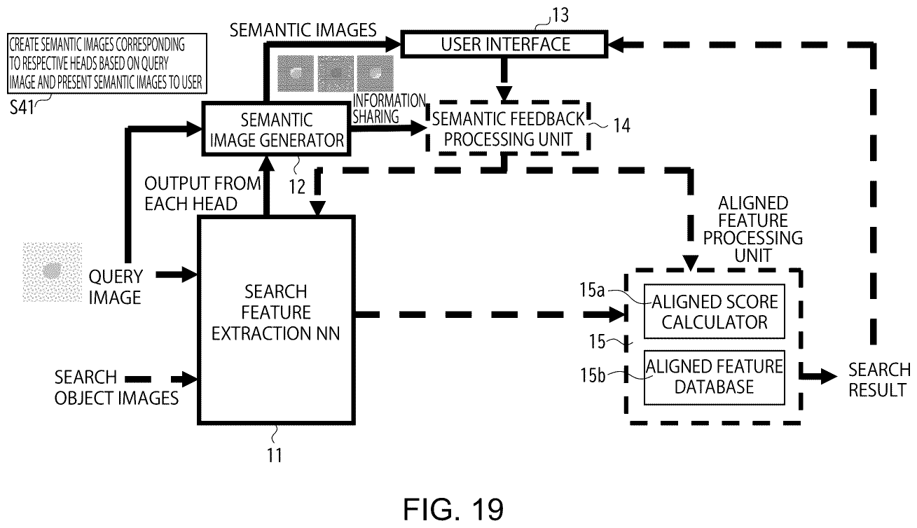

FIGS. 18 to 23 are diagrams for explaining the processing operation of the method A. As shown in FIG. 18, the method A includes steps S41 to S45. FIG. 18 shows all of steps S41 to S45 of the method A. FIGS. 19 to 23 each show details of each step.

First, as shown in FIGS. 18 and 19, the query image is inputted to the first part NN 11a of the search feature extraction NN 11 so that the heads 11h output a plurality of semantic features. The semantic image generator 12 generates a plurality of semantic images based on the query image and the semantic features, and presents the generated semantic images to the user (step S41). The search feature extraction NN 11 outputs a plurality of Aligned features corresponding to the semantic features. The Aligned feature processing unit 15 outputs scores corresponding to the semantic features based on the Aligned features, and sends a feedback to the user interface 13.

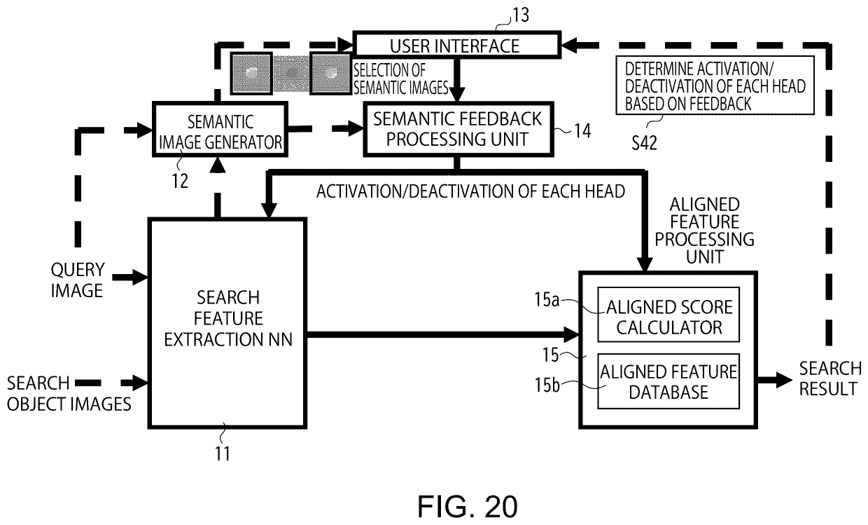

Next, As shown in FIGS. 18 and 20, the user refers to the scores fed back from the Aligned feature processing unit 15 to select one or more of the semantic images. By selecting the semantic images, whether each of the head 11h at the output portion of the first part NN 11a is activated or deactivated is determined (step S42).

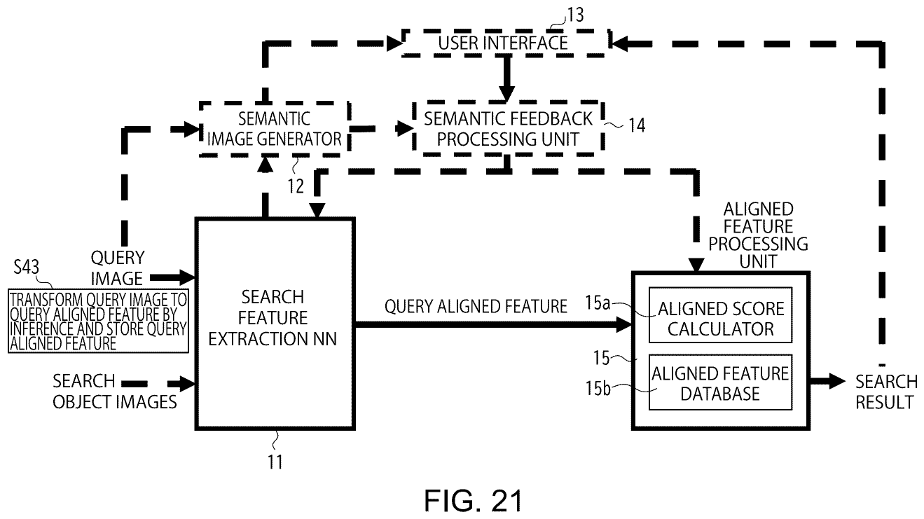

Subsequently, as shown in FIGS. 18 and 21, the query image is inputted to the search feature extraction NN 11 for inference, and the Aligned feature of the query image is outputted from the search feature extraction NN 11 and stored (step S43). Specifically, the feature of the query image is transformed to the Aligned feature at the search feature extraction NN 11, and stored.

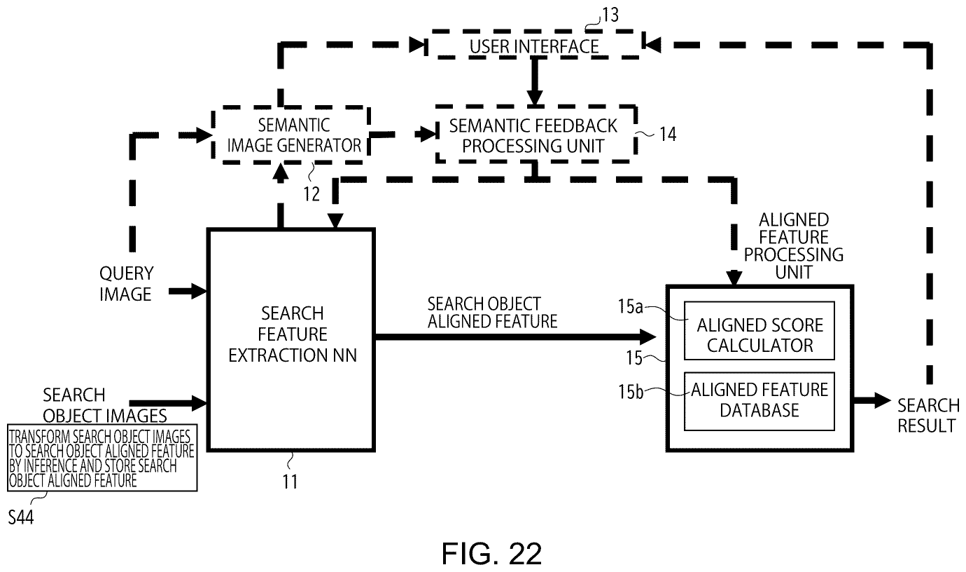

Thereafter, as shown in FIGS. 18 and 22, the search object images are inputted to the search feature extraction NN 11 for inference, and the Aligned features of the search object images are outputted from the search feature extraction NN 11 and stored in the memory (not shown) (step S44).

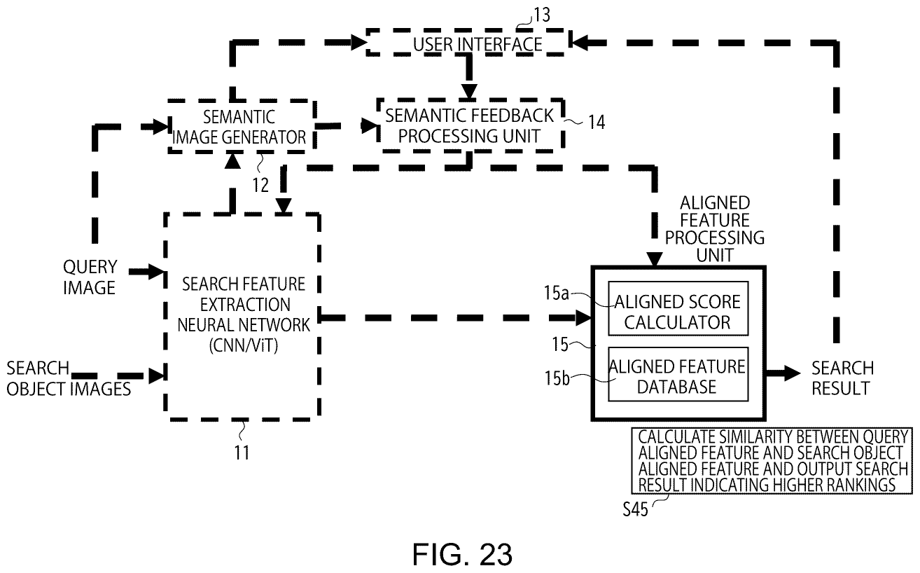

Next, as shown in FIGS. 18 and 23, the Aligned feature processing unit 15 calculates the degree of similarity between the Aligned feature of the query image and each of the Aligned features of the search object images and creates rankings of the search object images on the order of the degree of similarity (from the highest), and outputs search object images having higher rankings as a search result (step S45).

### (Method B)

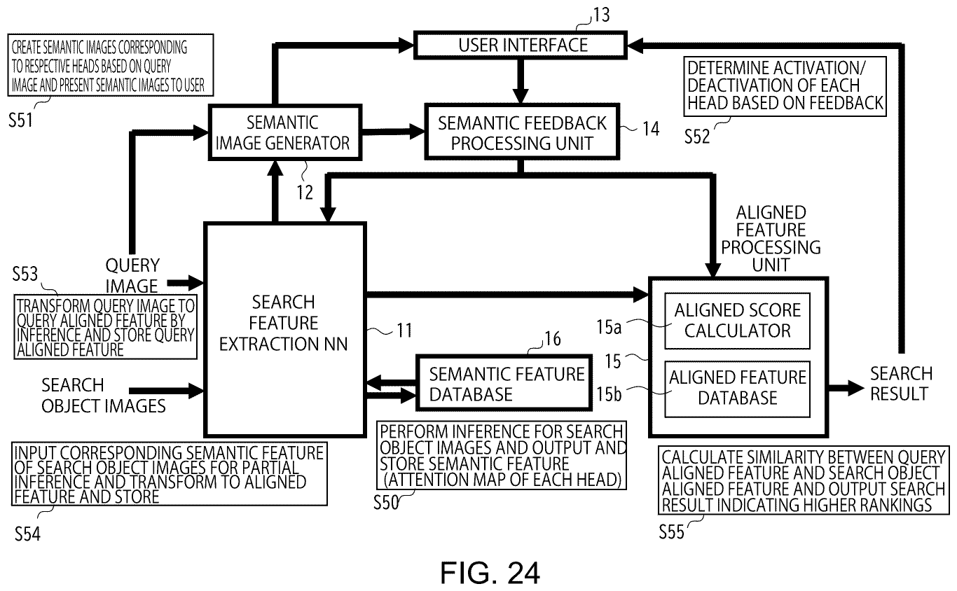

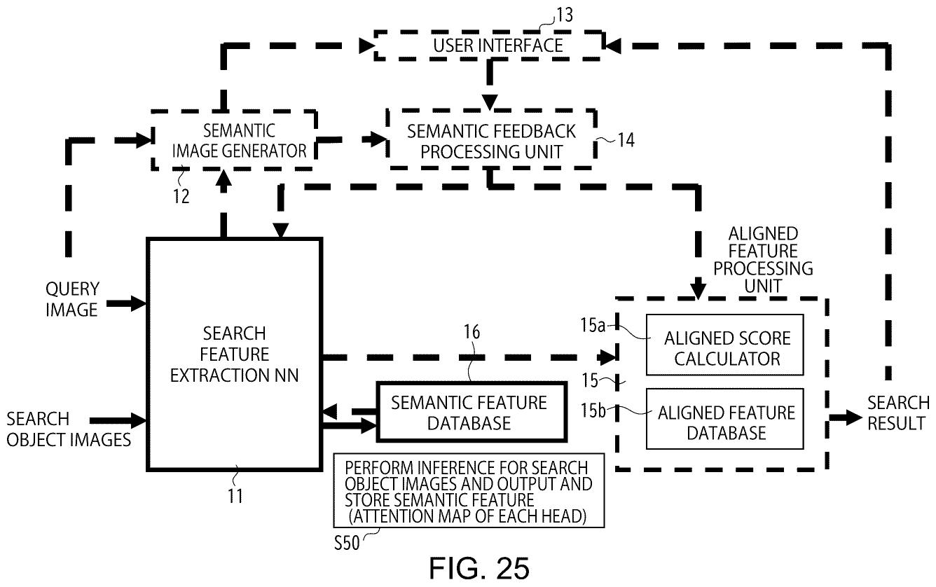

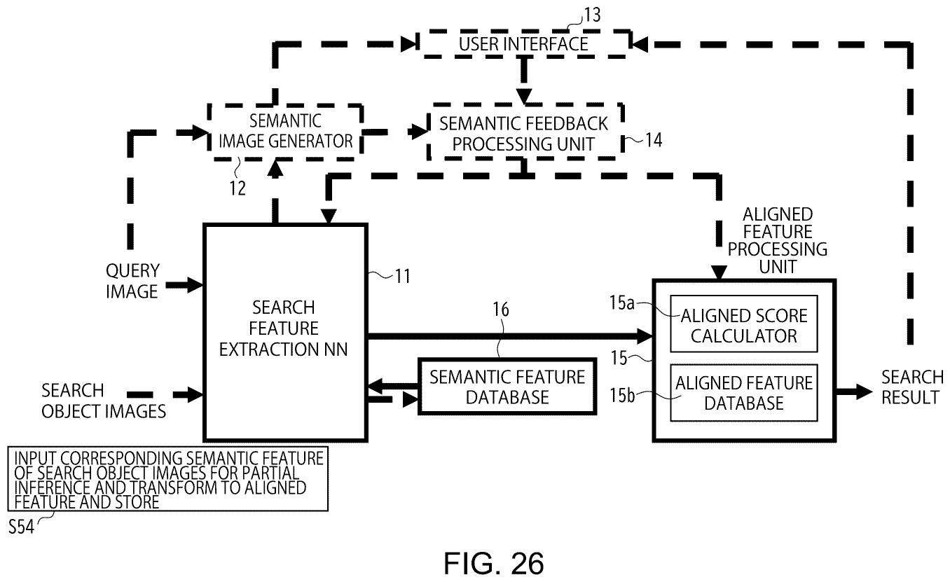

FIGS. 24 to 26 are diagrams for explaining a processing operation of the method B. As shown in FIG. 24, the method B includes steps S50 to S55. FIG. 24 shows steps S50 to S55, and FIGS. 25 and 26 show block diagrams relating to steps S50 and S54.

First, as shown in FIGS. 24 and 25, pre-processing is performed, the pre-processing including inputting the search object images into the search feature extraction NN 11 for inference, and outputting a semantic feature from the first part NN 11a and storing the semantic feature in the semantic feature database 16 (step S50). Thereafter, as shown in FIG. 24, processing is performed in the same manner as steps S41 to S43 shown in FIG. 18 (steps S51 to S53).

Next, as shown in FIGS. 24 and 26, a corresponding semantic feature of the search object images is acquired from the semantic feature database 16 and inputted into the search feature extraction NN 11 for partial inference, and an Aligned feature corresponding to the semantic feature is outputted from the search feature extraction NN 11 and inputted to the Aligned feature processing unit 15 (step S54).

Thereafter, as shown in FIG. 24, processing is performed in the same manner as step S45 shown in FIG. 18 (step S55).

In the method B, a semantic feature of the search object images is calculated in advance and stored in the semantic feature database 16, and when inference is performed, the semantic feature is read from the semantic feature database 16 and inputted to the second part NN 11b. Therefore, the calculation at the time of the inference may be facilitated.

### (Method C)

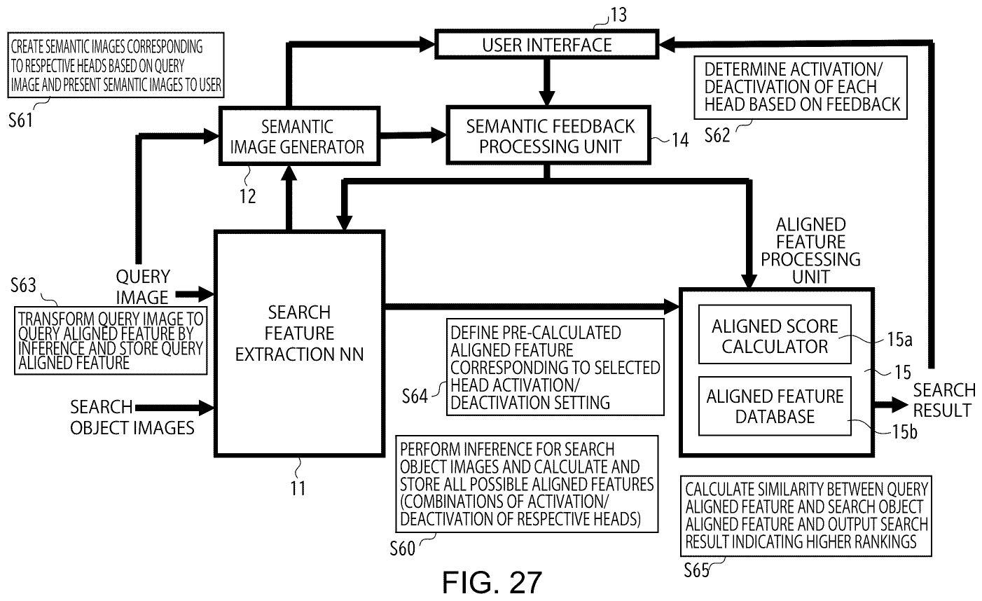

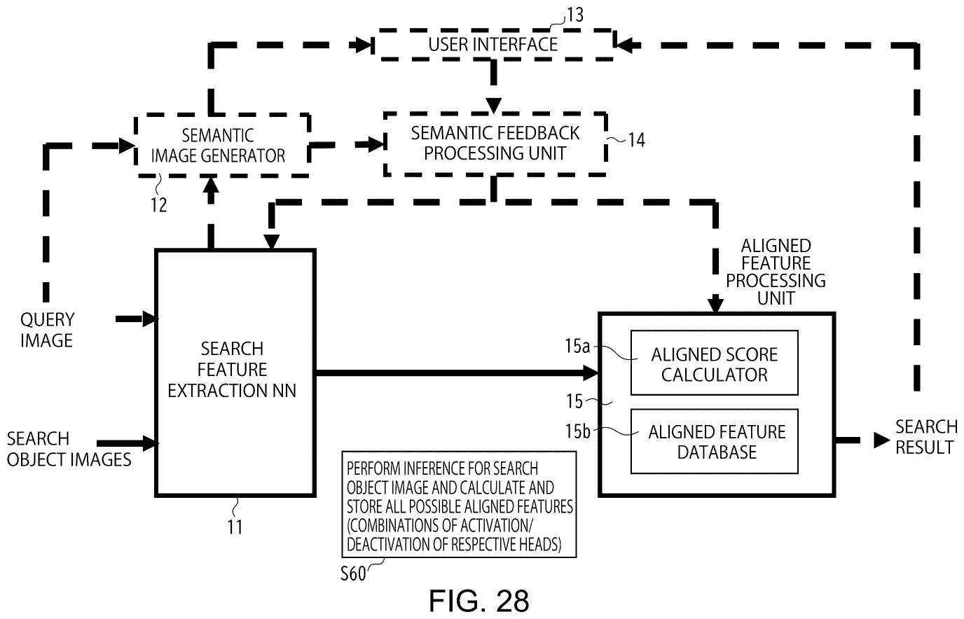

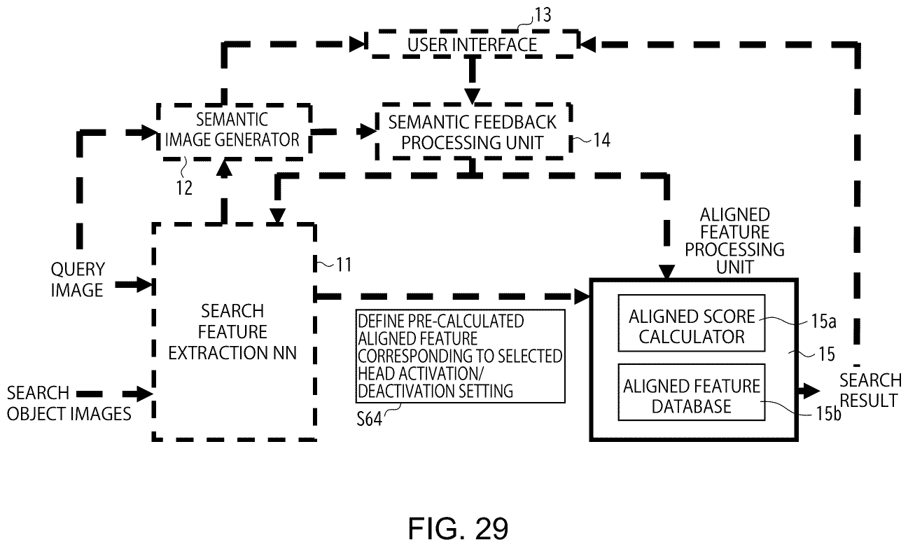

FIGS. 27 to 29 are diagrams for explaining a processing operation of the method C. As shown in FIG. 27, the method C includes steps S60 to S65. FIG. 27 shows all steps of the method C (steps S60 to S65), and FIGS. 28 and 29 show processing operations of steps S60 and S64, respectively.

First, as shown in FIGS. 27 and 28, as a pre-calculation before inference, the search object images are inputted to the search feature extraction NN 11 for inference, and all of Aligned features relating to all combinations of activation/deactivation of the heads 11h of the first part NN 11a are outputted to and stored in the Aligned feature database 15b (step S60).

Subsequently, as shown in FIG. 27, processing is proceeded in the same manner as steps S41 to S43 shown in FIG. 18 (steps S61 to S63).

Next, as shown in FIGS. 27 and 29, the pre-calculated Aligned features corresponding to the setting of the activation/deactivation of selected heads 11h are defined (step S64).

As described above, in the second embodiment, a plurality of heads 11h in an intermediate layer of the search feature extraction NN 11 are independently activated/deactivated to generate semantic features, and semantic images are generated based on the semantic features and the query image. The user selects a semantic image, and the activation/deactivation of the heads 11h is determined based on the semantic image selected by the user.

At the time of the inference, the Aligned feature processing unit 15 calculates the degree of similarity between the Aligned feature of the query image and the Aligned feature of each search object image and outputs a search result showing the rankings of higher degrees of similarity. By arbitrarily determining activation/deactivation of the heads 11h in the intermediate layer of the search feature extraction NN 11, the user may select from various semantic images. By reflecting the selection of the user in the training of the Aligned feature processing unit 15, the training may be performed depending on the types of the search object images.

At least a part of the information processing apparatus described with reference to each embodiment may be formed by hardware or software. If the information processing apparatus includes software, a program for performing at least a portion of the functions of the information processing apparatus is stored in a recording medium such as a flexible disk or a CD-ROM, and a computer may read such a program to perform the functions. The recording medium is not limited to detachable ones such as a magnetic disk or an optical disc, but may be fixed type recording medium such as a hard disk drive or a memory device.

A program for performing at least a portion of the functions of the information processing apparatus may be distributed via a communication lines (including wireless communication) such as the Internet. The program may be encrypted, modulated, or compressed and distributed via a wired or a wireless line such as the Internet or in a recording medium.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

1. An information processing apparatus comprising:
a first neural network configured to extract a feature of a query image and features of search object images;
a processing circuitry configured to:
detect a degree of similarity between each of the search object images and a query image based on the feature of the query image and the features of the search object images; and
calculate a score of each of the search object images based on the degree of similarity between each of the search object images and the query image and feature transformation information relating to the degree of similarity between each of the search object images and the query image;
a second neural network configured to output the feature transformation information based on the feature of the query image and the features of the search object images; and
a user interface configured to determine by a user the feature transformation information of each of the search object images based on at least one of the degree of similarity between each of the search object images and the query image or the score of each of the search object images,
wherein the processing circuitry is configured to provide, as feedback, the feature transformation information of the search object images determined by the user to the second neural network.

2. The information processing apparatus according to claim 1, wherein the user interface presents to the user a list of the search object images arranged in an order of the detected degree of similarity before the provided feedback, and presents to the user a list of the search object images arranged in an order of a magnitude of the score after the provided feedback.

3. The information processing apparatus according to claim 1,
wherein the first neural network is pre-trained, and
wherein a weight of the second neural network is updated by repeated operations of the processing circuitry and the user interface.

4. The information processing apparatus according to claim 3, wherein the feature transformation information outputted from the second neural network has a binary value or a Sigmoid function value.

5. The information processing apparatus according to claim 3, wherein the weight of the second neural network is updated for each of tags indicating different search intents.

6. The information processing apparatus according to claim 5, wherein the processing circuitry is further configured to:
update the weight of the second neural network based on the feature transformation information of the search object images determined by the user with respect to each of the tags; and
update the weight of the second neural network based on the repeated operations of the processing circuitry and the user interface for each of a plurality of query images with respect to a same tag.

7. The information processing apparatus according to claim 1,
wherein the processing circuitry is further configured to generate a pseudo feature that meets predetermined conditions for a plurality of features for which the feature transformation information is known, and
wherein the processing circuitry calculates the score based on the feature transformation information of each of the search object images and the feature transformation information corresponding to the pseudo feature.

8. The information processing apparatus according to claim 7, wherein the predetermined conditions include at least one of a condition relating to distances to the plurality of features in a feature space or a condition relating to an image processing method.

9. The information processing apparatus according to claim 1,
wherein the processing circuitry stores the feature of the query image and the features of the search object images extracted by the first neural network, and
wherein the processing circuitry stores the feature transformation information of each of the search object images with respect to the query image outputted from the second neural network.

10. The information processing apparatus according to claim 1,
wherein the user interface and the processing circuitry are used in a training phase in which a weight of the second neural network is updated, but are not used in an inference phase in which the second neural network is used,
wherein in the training phase, the processing circuitry calculates the score based on the degree of similarity before the second neural network outputs the feature transformation information, and calculates the score based on the feature transformation information after the second neural network outputs the feature transformation information.

11. An information processing apparatus comprising:
a neural network including a first part neural network extending from an input layer to an intermediate layer, and a second part neural network extending from the intermediate layer to an output layer, the neural network being configured to output first feature transformation information obtained by transforming a feature of a query image, and second feature transformation information obtained by transforming each of features of search object images;
a processing circuitry configured to:
generate intermediate images based on the query image and intermediate features outputted from the first part neural network when the query image is inputted to the neural network;
perform a feedback operation to select one or more of the intermediate features to be inputted to the second part neural network among the intermediate features outputted from the first part neural network based on the one or more of the intermediate images selected by the user; and
calculate a degree of similarity between the first feature transformation information of the query image that is inferred by inputting the query image to the neural network after the user selects the one or more of the intermediate images and the second feature transformation information of the search object images that is inferred by inputting the search object images to the neural network, and outputs a calculation result of the degree of similarity as a search result; and
a user interface configured to have a user select one or more of the intermediate images.

12. The information processing apparatus according to claim 11, wherein the user interface presents to the user the calculation result of the outputted degree of similarity before the user selects the one or more of the intermediate images.

13. The information processing apparatus according to claim 11,
wherein the first part neural network includes a plurality of heads each outputting the intermediate feature,
wherein each of the head is capable of being activated or deactivated,
wherein the intermediate feature outputted from an activated one of the heads is inputted to the second part neural network, and
wherein the first feature transformation information or the second feature transformation information is outputted from the second part neural network.

14. The information processing apparatus according to claim 13, wherein when all of the heads are activated, the neural network outputs a feature of the query image or the search object images inputted to the neural network, and when a part of the heads is deactivated, the neural network outputs the first feature transformation information or the second feature transformation information corresponding to the query image or the search object images inputted to the neural network.

15. The information processing apparatus according to claim 13,
wherein the heads are activated or deactivated based on the one or more of the intermediate images selected by the user,
wherein the neural network inputs the first feature transformation information to the processing circuitry, the first feature transformation information being generated by inputting to the second part neural network the intermediate features outputted from the heads corresponding to the one or more of the intermediate images selected by the user, and
wherein the processing circuitry outputs the calculation result corresponding to the intermediate feature, and sends the calculation result to the user interface as feedback.

16. The information processing apparatus according to claim 13,
wherein after the heads are activated or deactivated, the query image and the search object images are inputted to the neural network for inference,
wherein the processing circuitry calculates the degree of similarity between the query image and each of the search object images based on the second feature transformation information of each of the search object images outputted from the neural network and the first feature transformation information of the query image.

17. The information processing apparatus according to claim 13, further comprising a memory configured to store the intermediate features outputted from the first part neural network after the search object images are inputted to the neural network before inference is performed and before the user selects the one or more of the intermediate images,
wherein the processing circuitry calculates the degree of similarity between the first feature transformation information outputted from the neural network and the second feature transformation information outputted from the neural network, the first feature transformation information being obtained by inputting the query image to the neural network and inputting the intermediate features outputted from the heads and corresponding to the one or more of the intermediate images selected by the user to the second part neural network, and the second feature transformation information being obtained by inputting the intermediate features stored in the memory to the second part neural network for performing partial inference.

18. The information processing apparatus according to claim 13, further comprising a memory configured to store the second feature transformation information outputted as a result of inference performed by inputting the search object images to the neural network with respect to all combinations of activation and deactivation of the heads before the user selects the one or more of the intermediate images,
wherein the processing circuitry reads from the memory the second feature transformation information corresponding to the heads relating to the one or more of the intermediate images selected by the user to calculate the degree of similarity.

19. The information processing apparatus according to claim 11,
wherein the neural network has a vision transformer configuration in which the intermediate layer includes a plurality of heads,
wherein each of the heads has a multi-head attention mechanism.

20. An information processing method comprising:
extracting, by a first neural network, a feature of a query image and features of search object images;
detecting a degree of similarity between each of the search object images and the query image based on the feature of the query image and the features of the search object images;
outputting, from a second neural network, feature transformation information relating to the degree of similarity between each of the search object images and the query image based on the feature of the query image and the features of the search object images;
calculating a score of each of the search object images based on the feature transformation information and the degree of similarity between each of the search object images and the query image;
determining by a user the feature transformation information of each of the search object images based on at least one of the degree of similarity between each of the search object images and the query image or the score of each of the search object images; and
providing as feedback the feature transformation information of the search object images determined by the user to the second neural network.
